(19) United States
(12) Patent Application Publication
(10) Pub. No.: US 2005/0202232 A1
(43) Pub. Date: Sep. 15, 2005

(54) Melamine foam sheet article and method for making same

(76) Inventor: Jean Sauniere, HOSSEGOR (FR)

Correspondence Address: YOUNG & THOMPSON, 745 SOUTH 23RD STREET, 2ND FLOOR, ARLINGTON, VA, 22202, US

(21) Appl. No.: 10/517,526

(22) PCT Filed: Jun. 10, 2003
(86) PCT No.: PCT/FR03/01725

§ 371 Date: Dec. 13, 2004

(30) Foreign Application Priority Data
Jun. 11, 2002 (FR) 02/07140

(51) Int. Cl. B32B 3/26

(52) U.S. Cl. 428/316.6; 428/304.4; 428/317.1

(57) ABSTRACT

A method for making an article (1) including at least a sheet melamine (2, 2′) foam piece with thickness sufficiently thin to exhibit flexibility and no flexural elasticity, which consists in: cutting by peeling a melamine foam block (40) into a strip with thickness sufficiently thin to exhibit flexibility and no flexural elasticity, and in making the article (1) using at least one sheet melamine foam piece derived from the strip. An article obtained by the inventive method can be used for many applications, in particular, in for surface cleaning, where it can advantageously be substituted for a standard double-faced sponge substantially identically. Such an article exhibits, when used as a towelette, flexibility and no flexural elasticity which makes it easy to use. Moreover, it is more hygienic than a double-faced sponge since it is disposable.

The present invention relates to the field of articles comprising at least one piece of melamine foam.

In some applications, it may be beneficial to have articles composed of at least one sheet of melamine foam or comprising at least one such sheet of melamine foam. At present however, there is no industrial method for making a piece of sheet-form melamine foam exhibiting a thickness which is sufficiently small to exhibit flexibility and no flexural elasticity.

Melamine foams are flexible open-cell foams produced on the basis of melamine resin and are basically characterized by a very low density, good qualities of acoustic and thermal insulation, good chemical resistance to solvents and corrosive agents, excellent dimensional stability, etc. They are generally used in the field of building and of transport (automotive, railway, aeronautical, etc. construction).

More surprisingly, on account of their liquid-absorbing capacity and their abrasive power, melamine foams are also used in the design of certain types of sponge. Owing to their great mechanical fragility, in particular when subjected to tearing and friction, however, they have only been used up until now in the form of blocks or layers of relatively great thickness (JP 2001-258809, DE 201 09 652 U1), of at least approximately a centimeter. There was no known method for producing pieces of sufficiently small thickness for obtaining a flexible sheet exhibiting no flexural elasticity, in particular having a thickness of less than a millimeter. Furthermore, it is not known to obtain fine sheets of foam based on such a fragile, brittle material. In addition, a layer of melamine foam having a thickness of less than a millimeter cannot be obtained directly by known methods of melamine foam synthesis.

The invention also extends to the applications of such pieces of sheet-form melamine foam, in other words to articles comprising at least one piece of sheet-form melamine foam. Such an article, of various formats, may be used for numerous applications. For example, it may be formed by a strip or band which may be cut on site for covering floors, walls or any room surfaces.

More particularly, however, it may be used as an article for cleaning surfaces intended for domestic or professional (factories, laboratories, hospitals, etc.) use—in particular for maintenance or cleaning (household tasks, vehicle washing, etc.). The invention therefore relates quite particularly to articles of the rag, mop, paper towel, towelette, etc. type, which may be used for both damp cleaning and non-damp cleaning.

Rags, cloths, mops, etc. are conventionally used in the field of both domestic and professional cleaning. These articles are generally made of woven fabric, in particular of cotton, and, in addition to a liquid-absorbing capacity, have strength and resistance adapted to their use, which sometimes necessitates intense rubbing (dust removal, floor washing, dish washing). These articles are rinsed and/or washed after one or more uses, are often intended for repeated use and are usually required to have a fairly long service life.

These pieces of fabric, which are often malodorous and have a rather repulsive appearance, harbor mites, microbes, fungi, and are a source of insalubrity. Substantially for reasons of hygiene, therefore, it is preferable that these articles, which are used in stages of surface cleaning, are discarded quickly after a single use.

Disposable articles basically made of cellulose fibers, such as rolls of absorbent paper, often known as “household paper” or “paper towels”, have recently been developed. In addition to improving hygiene (as it is discarded after a single use), a paper towel greatly facilitates daily housework and substantially reduces detergent consumption.

As they are basically made of cellulose fibers in order to reduce the cost, however, these articles exhibit not only a soft feel, which makes them unsuitable for scouring, but also a further major drawback: their fragility. Therefore, they are unsuitable for intense rubbing of a surface to be cleaned, particularly if this surface is rough. In addition, their fragility is accentuated when they are moistened. It is impossible to wring them without damaging their structure, so they become inoperative once they are waterlogged.

Cleaning towelettes having an intermediate structure between those of disposable and multiple-use articles are also known. These towelettes are composed of a thickness of foam or of woven or agglomerated (nonwoven) natural or synthetic fibers which may have been previously impregnated, prior to the sale thereof, with a lotion intended to act on soiling and thus reduce the rubbing force. The liquid compositions possibly used are generally detergents, antibacterial and/or fungicidal solutions, etc. These ready-to-use articles require neither moistening nor addition of other conventional household products. The quantity of lotion is adjusted so that the towelette can be as effective as possible against soiling and can maintain satisfactory strength for a more or less specific application.

However, the scouring capacity of these towelettes, which are pleasant to handle, is inadequate for dealing with tenacious soiling such as, for example, dry soiling encrusted in a surface which is not completely smooth.

What are known as “double-faced” sponges are also known, which combine a scouring pad, a few millimeters thick, with a conventional absorbent sponge of greater thickness (greater than 1 cm), and detach the dirt by rubbing with the scouring face and perform damp cleaning and/or absorption owing to the thickness of the sponge.

Sponge-type cleaning articles having a bi-functional body, which is both an absorber and a scourer, made of melamine foam are also known (JP 2001-258809, DE 201 09 652 U1). Owing to the very great fragility, characteristic of melamine foams, when subjected to tearing and abrasion, these bi-functional bodies have hitherto had great thicknesses of at least approximately a centimeter and cannot be used as they are. To overcome these deficiencies in strength, JP 2001-258809 recommends the addition of a gripping element made of an elastic foam having mechanical strength, in particular tensile strength and tear strength, which are higher than that of melamine foams. DE 201 09 652 U1 proposes modifying the cellular structure of the melamine foams by thermocompression and, optionally, embossing the surface to modify the roughness thereof and thus improve the cleaning power thereof.

Although they are still very widely used in the domestic sphere nowadays, whether double-faced and/or of melamine foam, these sponges do not meet the hygiene requirements and, even less, the sanitary requirements. In recent years, there has been an increase in awareness of the presence of germs within dwellings. From among these germs, in particular of the bacterial type, some have proven to be fatal to humans on several occasions. This applies to salmonella and listeria. As the bacteria are basically transmitted by infected water and by food, a slightly damp sponge, which is never completely clean, is a trouble spot of contamination and a haven for the proliferation of millions of bacteria. This has been revealed by a study carried out in “the experimental kitchen” at the Pasteur Institute (Pasteur Institute—archives 01/010605).

Therefore, there is a real need nowadays to replace sponges, of whatever type, with cleaning articles that satisfy sanitary and hygiene criteria. At present, there is no article capable of satisfactorily replacing absorbent scouring sponges which, while being disposable, maintains qualities and properties equivalent to those of sponges in each of their normal applications (which range from the mere cleaning of a smooth surface, to the scouring of an old saucepan with cooked food attached).

The invention therefore aims firstly to propose a method of making an article comprising at least one piece of sheet-form melamine foam with a thickness which is sufficiently small to exhibit flexibility and no flexural elasticity and which is compatible with the constraints of an industrial business, in particular in terms of price and cost-effectiveness. The invention also aims to propose such an article.

The invention aims, in particular, to propose a cleaning article which is both an absorber and a scourer and is also disposable, in other words intended for a single use or a quasi-single use (a few successive uses).

The invention also aims to propose such an article which is inexpensive in composition and production.

A further object of the invention is to propose an article which is sufficiently strong to be able to perform cleaning tasks necessitating intense rubbing on a rough surface, even when damp or even in the presence of a large quantity of water.

The present invention firstly relates to a method for making an article comprising at least one piece of sheet-form melamine foam having a thickness which is sufficiently small to exhibit flexibility and no flexural elasticity, wherein a melamine foam block is cut by peeling into a strip having a thickness which is sufficiently small to exhibit flexibility and no flexural elasticity, and wherein the article is made using at least one piece of sheet-form melamine foam derived from this strip.

A melamine foam which is suitable as a starting material according to the invention includes the one produced by the method described in U.S. Pat. No. 4,666,948 or else the BASOTECT® produced and sold by the company BASF, Germany.

The invention is based on the demonstration, for the first time, of the possibility of obtaining pieces of melamine foam with a thickness that is sufficiently small to obtain a sheet exhibiting flexibility and no flexural elasticity, in particular with a thickness of less than a millimeter. For this purpose, with a method according to the invention, a block of melamine foam is cut by peeling, using a peeling machine.

Peeling, which is a method employed in the timber industry, allows a cylinder of material to be cut into thin blades. For this purpose, said cylinder of material set into rotation in front of a sharpened blade is cut, the distance between the axis of rotation of said cylinder and the blade gradually decreasing during rotation of the cylinder. The thickness of the strip basically depends on the resultant between the speed of rotation of the cylinder and the speed at which the axis of rotation and the blade of the peeling machine come together.

In the timber industry, the strip cut by the blade is generally also cut transversely and optionally longitudinally to obtain blades which may be used, for example, for the production of packaging baskets.

The inventor has surprising found that, despite the great fragility and the brittle nature of melamine foams, cutting by peeling a block melamine foam in a continuous thin flexible strip exhibiting no flexural elasticity may be carried out with great reliability (little risk of breakage of the strip during peeling) and at a high speed. This finding has allowed pieces of melamine foam to be obtained for the first time, which are of sufficiently small thickness to exhibit flexibility and no flexural elasticity.

No other method for obtaining a layer of melamine foam with a thickness smaller than a millimeter is currently known.

Advantageously, a method according to the invention is carried out for producing an article having two opposing main free faces with a total thickness which is sufficiently small to exhibit flexibility and no flexural elasticity, wherein at least one layer, known as the reinforcing layer is attached to each piece of melamine foam, so that at least one of the main free faces of said article has a scouring free face formed at least in part by at least one piece of melamine foam.

A method according to the invention therefore allows articles which are particularly beneficial for cleaning to be produced from a melamine foam. Owing to their small thickness, these articles are flexible and may be used as paper towels, rags or towelettes. However, they have an abrasive free face, which is not smooth and advantageously allows intensive scouring operations. As they require only very little material and materials that are already commercially available at reasonable prices, the cost of producing these articles may be very low so they may be produced and sold for single or quasi-single use.

To obtain an article with a thickness that is sufficiently small to exhibit flexibility and no flexural elasticity, strips having a thickness of less than or equal to 1 mm, preferably of approximately 0.8 mm are advantageously cut by peeling.

Advantageously and according to the invention each piece of melamine foam is attached to at least one reinforcing layer so as to obtain a melamine foam layer having a main face which defines a scouring free face of the article and, superimposed on the melamine foam layer, a reinforcing layer of this type having a main face that defines the other free face of the article.

According to the invention, a layer of melamine foam with a small thickness and a reinforcing layer of a suitable material are merely superimposed. Such an assembly produces an article of the towelette type, with a main free face formed by the layer of melamine foam and a further main free face formed by the reinforcing layer. The reinforcing layer may be a layer of melamine foam. It may also be a layer distinct from a melamine foam and adapted to have tear strength which is higher than that of melamine foam. In this case, the reinforcing layer ensures that the completeness of the layer(s) of melamine foam is maintained throughout its use.

Advantageously, a method according to the invention allows production of an article, at least one of the main free faces of which is an absorbent free face formed at least in part by at least one piece of absorbent material. This piece of absorbent material can form a reinforcing layer of an absorbent material, whether or not of melamine foam.

According to a preferred embodiment, an article is produced, which comprises a layer of melamine foam having a main face defining the scouring free face of the article and, superimposed on the melamine foam layer and made of an absorbent material, a reinforcing layer having a main face defining the absorbent free face of the article.

Thus, although it may resemble an article of the paper towel or towelette type, owing to its flexibility, its small thickness and its disposable nature, an article according to the invention has good tear strength and advantageously affords the functional advantages of a double-faced sponge: absorption and scouring capacity. An article produced according to the invention advantageously allows conventional double-faced sponges to be substituted in an at least substantially equivalent manner while also exhibiting great flexibility which facilitates the use thereof, and while being disposable and therefore more hygienic.

Advantageously and according to a further variation, the opposing main free faces of an article according to the invention are both scourers and formed by two distinct layers of melamine foam, between which at least one reinforcing layer is interposed.

Advantageously and according to the invention, an article having a total thickness of less than 5 mm, preferably of approximately 0.85 to 2 mm is produced.

Advantageously and according to the invention, each reinforcing layer is produced from a fibrous material mainly containing fibers selected from: cellulose fibers, natural textile fibers, synthetic textile fibers.

Advantageously and according to the invention, each reinforcing layer is produced from a material selected from: a cellulose nonwoven, a viscose nonwoven, a perforated cotton nonwoven, a polyamide knit, a cotton gauze, a polyurethane foam, a polyethylene foam.

Merely by way of non-limiting examples, commercially available materials that may be used as an absorbent reinforcing layer according to the invention and which merely have to be integrally combined with the melamine foam layer(s) to obtain an article according to the invention include sheets of absorbent paper made of cellulose fibers, paper handkerchiefs, dusting rags made of cellulose or cotton wadding, pieces of gauze used in the medical or cosmetic field, etc.

It is obvious that the use of an absorbent material different from a melamine foam as a reinforcing layer according to the invention is merely a variation of a method according to the invention. For certain applications, this variation of the invention may advantageously be considered to improve the liquid-absorbing capacity and the performance of an article according to the invention. In the case of an article according to the invention intended, for example, for dry scouring or for any other task where the absorption of liquids is not an important criterion, the presence of an absorbent reinforcing layer is not essential. Any suitable layer of material having tear strength higher than that of the melamine foam layer may be suitable (a sheet of paper, of cardboard, a plastics film, etc.).

Advantageously and according to the invention, at least a portion of the thickness of said article is impregnated with a liquid composition, before the article is packaged.

Owing to the chemical stability of melamine foams and to their resistance to solvents and chemicals (generally in accordance with the standard DIN 53428), said article may be imbibed with liquid compositions of greatly varying natures and compositions.

Advantageously and according to the invention, the liquid composition used is selected from: a detergent, a solvent, a bacteriostatic and/or bactericidal disinfectant composition, water or a mixture thereof.

An article produced by a method according to the invention may be used for various purposes, for example, but not only, domestic or industrial cleaning. An article according to the invention may also be used for cleaning and care of the body (for cosmetic or curative purposes), for example the form of a bath sponge, a make-up removing pad, rubber or towelette for removing dead skin, disinfectant cotton or dressing, etc. With this range of application, therefore, at least a portion of its thickness is advantageously impregnated with a liquid composition selected from among: a moisturizing solution, a soap, a deodorant, a perfume, a make-up removing composition, an emollient, an ointment, an antiseptic, water, hydrogen peroxide solution or a mixture thereof.

In a variation, a solid composition capable of dissolving in the presence of a liquid—in particular water—is incorporated in at least a portion of the thickness of said article so as to be able to release an active agent.

Advantageously, in order to preserve the functional and structural characteristics of an article obtained according to the invention and, more particularly, the functional characteristics of the liquid or solid composition, at least during a storage period of sufficient duration, said article is wrapped in an individual or collective impermeable packaging.

Advantageously and according to the invention, when said article is impregnated with a liquid composition as defined hereinbefore, a packaging compatible with this impregnation is used.

Advantageously and according to the invention, the various layers of said article are laminated using an intermediate heat-activable adhesive film.

The use of a heat-activable film to bond the various constituent layers of an article according to the invention is presented here merely as a variation. Therefore, it does not limit the scope of the invention, in particular to indirect adhesion of these various layers. The choice of methods and, in particular, the adhesive composition for bonding these layers is generally appreciated as a function of the nature of the reinforcing layer.

In certain cases, no adhesive composition is required, for example if the reinforcing layer itself has a capacity to bond with the melamine foam. This is the case, for example, if the reinforcing layer is produced by printing or spraying directly on one of the faces of a layer of melamine foam, an aqueous composition adapted to dry to a film which is thus stuck directly to the melamine foam.

The invention extends to an article obtained by a method according to the invention. Said article comprises at least one piece of sheet-form melamine foam with a thickness that is sufficiently small to exhibit flexibility and no flexural elasticity.

Advantageously and according to the invention, said article is characterized
in that at least one of the main free faces is a scouring free face formed at least in part by at least one piece of melamine foam,
in that it comprises at least one layer known as the reinforcing layer associated with each piece of melamine foam remote from the part of the scouring free face formed by this piece.

Advantageously and according to the invention, at least one of the pieces of melamine foam has a thickness of less than or equal to 1 mm, preferably of approximately 0.8 mm.

Advantageously, the article according to the invention comprises a layer of melamine foam having a main face defining a scouring free face of the article and, superimposed on the layer of melamine foam, a reinforcing layer having a main face defining the other free face of the article. An article according to the invention may thus be very simple in design and merely involve the superimposition of a layer of melamine foam and a reinforcing layer made of a suitable material. Such an article according to the invention therefore has a main free face formed by the flexible layer which exhibits no flexural elasticity of melamine foam and another main free face formed by the reinforcing layer which is also flexible and exhibits no flexural elasticity.

Advantageously and according to the invention, at least one of the main free faces is an absorbent free face formed at least in part by at least one piece of absorbent material. This piece of absorbent material may be the reinforcing layer itself or else the piece(s) or the layer(s) of melamine foam.

Advantageously, a reinforcing layer according to the invention is made of an absorbent material which is distinct from a melamine foam and is adapted to have tear strength that is higher than that of melamine foam. Therefore, although it may resemble an article of the paper-towel or towelette type, owing to its small thickness, its flexibility, its absence of flexural elasticity and its disposable character, an article according to the invention has good cohesion and good tear strength and advantageously affords the functional advantages of a double-faced sponge: absorption and scouring capacity. It has, in particular, scouring properties that are far superior to those of known towelettes. An article according to the invention may therefore be substituted at least substantially equivalently for a conventional double-faced sponge. An article according to the invention also has, like a towelette, flexibility and no flexural elasticity, which facilitate its use. In addition, it is disposable and therefore more hygienic than a double-faced sponge.

Advantageously and according to a further variation of the invention, the opposing main free faces of an article according to the invention are both scouring faces and are formed by two distinct layers of melamine foam between which at least one reinforcing layer is interposed.

Advantageously, an article according to the invention has a thickness of less than 5 mm, preferably of approximately 0.85 to 2 mm, in other words far less than that of a conventional sponge.

Advantageously and according to the invention, each reinforcing layer is produced from a fibrous material mainly containing fibers selected from: cellulose fibers, natural textile fibers, synthetic textile fibers.

Advantageously and according to the invention, each reinforcing layer may also be produced from a material selected from: a cellulose nonwoven, a viscose nonwoven, a perforated cotton nonwoven, a polyamide knit, a cotton gauze, a polyurethane foam, a polyethylene foam.

Advantageously, at least a portion of the thickness of an article according to the invention may be impregnated with a liquid composition, before the packaging thereof (for the storage, transit and sale thereof).

Advantageously and according to the invention, the liquid composition is selected from: a detergent, a solvent, a bacteriostatic and/or bactericidal disinfectant composition, water or a mixture thereof.

Advantageously and in a variation, at least a portion of the thickness of the article according to the invention is impregnated with a liquid composition selected from: a moisturizing solution, a soap, a deodorant, a perfume, a make-up removing composition, an emollient, an ointment, an antiseptic, water, hydrogen peroxide solution or a mixture thereof.

Instead of being imbibed with a liquid composition, an article according to the invention may also advantageously comprise in at least a portion of the thickness thereof a solid composition intended to dissolve in the presence of a liquid—in particular water—so as to be able to release an active agent.

Advantageously, an article according to the invention is wrapped so as to maintain its functional characteristics and, more particularly, those of the liquid or solid composition, at least for a storage period of sufficient duration.

Advantageously, an article according to the invention is wrapped in an individual (for example closed pouch) or collective (dispensing closed box) impermeable packaging. If an article according to the invention is impregnated with a liquid composition, as defined hereinbefore, the selected packaging is compatible with this impregnation.

Advantageously and according to the invention, the various layers and/or pieces of an article according to the invention may be laminated using an intermediate heat-activable adhesive film.

The invention also relates to a method of making an article comprising at least one piece of melamine foam and to an article obtained by this method which may be intended for multiple applications and, more particularly, the cleaning and/or maintenance of surfaces, characterized, in combination, by all or some of the foregoing or following characteristics.

Further objects, characteristics and advantages of the invention will emerge on reading the following examples which refer to the accompanying drawings, in which:

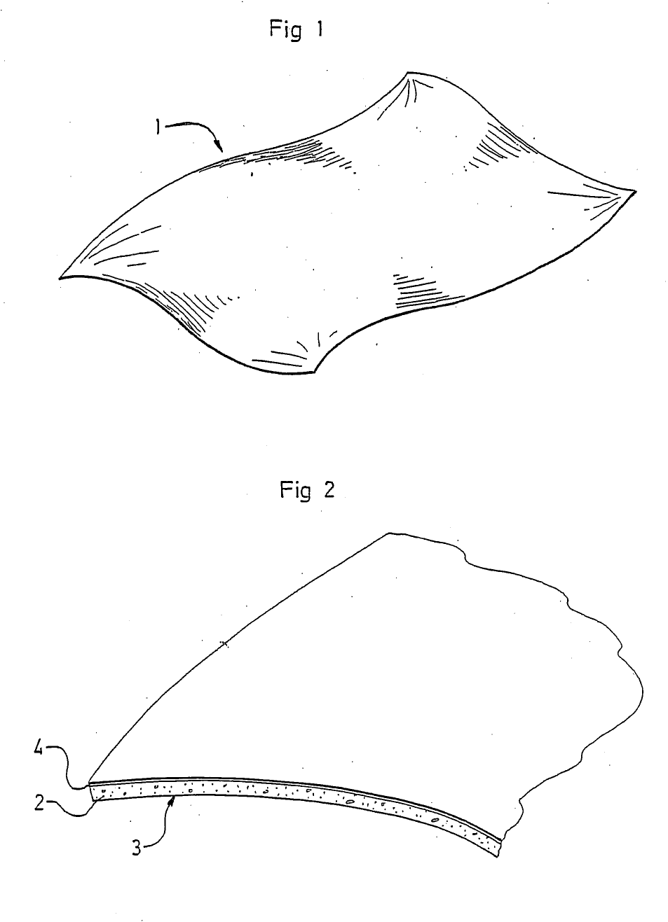

FIG. 1 is a general view of an absorbent scouring article according to the invention,

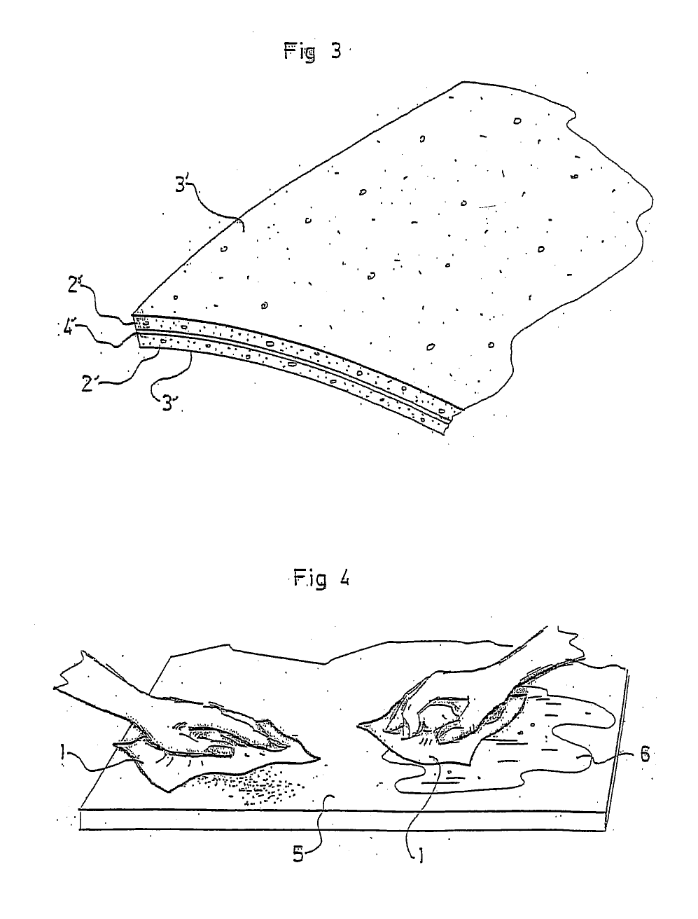

FIGS. 2 and 3 are partial sectional views of two variations of an absorbent scouring article according to FIG. 1; FIG. 2 accordingly shows a first variation of an article according to the invention of which a single main free face is made of melamine foam, and FIG. 3 shows a second variation in which the two main free faces are made of melamine foam,

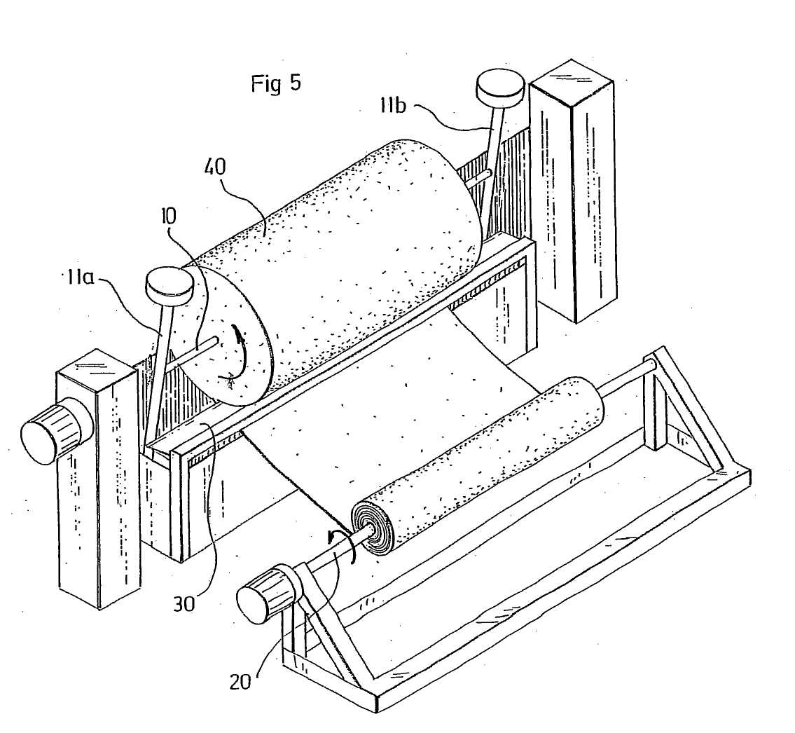

FIG. 4 illustrates the multiple use of an article according to the invention,

FIG. 5 is a schematic view of a peeling machine for carrying out a method according to the invention.

FIG. 1 shows a double-layered article 1 according to the invention which, owing to its small thickness, which is advantageously less than 5 mm, in particular approximately a millimeter, and its flexibility, resembles a disposable cleaning article of the rag, paper towel or towelette type.

As shown in FIG. 4, an article of this type, which is very flexible and exhibits no flexural elasticity, is easy to grasp and pleasant to handle. Owing to its scouring power, its capacity to absorb liquids and good tear strength, it is suitable for numerous cleaning operations (damp and non-damp cleaning) for surfaces 5 and advantageously fulfils the functions of a conventional double-faced sponge.

As shown in FIG. 4, this article 1 allows cleaning operations involving the least effort such as dusting, the cleaning of solid dirt that is not encrusted on the surface 5, the sponging of a liquid 6, etc. It also allows intensive operations of scouring the surface 5, even if the surface 5 is rough. This scouring, which is achieved by mere rubbing, may involve the mere abrasive power of the article 1 or involve other household products to facilitate this operation.

According to a first variation of the invention, an article 1 has a single layer of melamine foam 2. Shown at the bottom of FIG. 2, this single layer has a main surface that is at least substantially equal to that of the main free faces of the article 1. In other words, the main free scouring face 3 of the single layer of melamine foam 2 itself forms the free scouring face of the article 1 which is adapted for application to a surface 5 to be treated, in particular to be cleaned, where it exerts a scouring effect if it is rubbed against this surface 5.

This layer of melamine foam 2 has a thickness of less than a millimeter, for example of approximately 0.8 mm.

The layer of melamine foam 2 is obtained by peeling from an initial block of melamine foam using a peeling machine, for example one of the models sold by the company FECKEN-KIRFEL, Germany.

BASOTECT®, which is produced and sold by the company BASF, Germany, may be used as a starting product for carrying out the method according to the invention. BASOTECT® is generally sold by this company in the form of a block measuring 2500×1250×500 mm, but may also be sold with special dimensions on request.

FIG. 5 is a schematic view of the general operation of a conventional peeling machine.

Schematically, a peeling machine consists of a cylindrical upper shaft 10 and lower shaft 20 disposed in parallel with one another and set into rotation separately by two synchronously operating motors. The upper shaft 10 which is slidably mounted by its ends on a pair of guide rails 11a and 11b is set into translation along said rails 11a and 11b by the actual rotation of the upper shaft 10 about its axis. This rotation causes the axis of the upper shaft 10 to gradually approach the cutting edge of the stationary elongate blade 30 placed below the upper shaft 10 and substantially in the horizontal plane defined by the axis of the lower shaft 20. The elongate cutting blade 30 extending over at least a portion of the length of the upper shaft 10 allows the tangential cutting into a strip of a cylindrical piece generated by revolution of melamine foam 40 mounted on the upper shaft 10. The cut foam strip is thus wound round the lower shaft 20 during the cutting operation.

The regulation and adjustment of the cutting conditions as a function of the desired strip thickness and the nature of the worked material fall within the competence of a person skilled in the art familiar with the operation of peeling machines.

If the melamine foam block is in an initial parallelepiped form, it is mounted on the upper shaft 10 of the peeling machine and is gradually cut up to obtain a cylinder 30 generated by revolution. Only then is it possible to withdraw a strip end which will be fixed to the lower shaft 20.

Starting with the foam strips thus obtained, strips are drawn to the desired formats. These strips are stuck to sheets which are adapted to act as reinforcing strips 4 and have a main surface connected to that of the melamine sheets and have tear strength higher than that of melamine sheets. An absorbent paper, for example a paper handkerchief, a paper towel or a fabric made of cotton fiber, for example a dusting rag, etc. may be used as the reinforcing layer 4. Such combinations lead to a fine flexible article with high tear strength which is convenient to grasp and easy to use. Other absorbent or non-absorbent materials may also be used and are selected as a function of the liquid-absorbing capacity and also as a function of the mechanical strength desired in the final product.

Lamination may be carried out indirectly and very simply using various types of adhesive. For example, lamination by hot pressure is particularly beneficial. For this purpose, a film of heat-activable adhesive substance, not shown in FIG. 2, is interposed between the two constituent layers 2 and 4 of the article 1 and a hot pressure exerted on the contact zones joins together the assembly.

Further methods of production lead to manufacture of the article 1. For example, in a first phase there may be produced a two-layered structure comprising a layer of melamine foam and a reinforcing layer which are naturally cohesive or laminated, have a large area (with dimensions much greater than 250 mm×250 mm) and of which the melamine layer has a thickness of less than or equal to a millimeter. Starting with this two-layered structure, articles 1 having the desired dimensions are released by a final cut.

A second range of articles 1 according to the invention is proposed in a non-limiting manner. An article 1, as shown in FIG. 3 comprises two layers of melamine foam 2′ exposing two free scouring faces 3′ toward the exterior. These two layers of melamine foam 2′ are connected by a reinforcing layer 4′. This reinforcing layer 4′ laminated to the two layers of melamine foam 3′ gives both better tear strength.

The reinforcing layer 4′ is produced from absorbent material, so it can also improve the absorption capacity of the assembly.

The two ranges of articles presented hereinbefore are perfectly suitable for non-damp cleaning of a solid surface or for cleaning thereof with slight moistening.

In the case of cleaning which necessitates the use of a high liquid content (cleaning of floors, crockery, etc.), it is preferable to use an article 1 comprising, as reinforcing layer 4 or 4′, a material having high water tolerance, for example a woven or nonwoven fabric made of cotton fibers or else a gauze (rather than a cellulose fiber nonwoven fabric).

The article 1 may advantageously contain a liquid composition, in particular a cleaning composition (a detergent, a disinfectant, a degreaser, etc.). This article 1 therefore corresponds in this case, to a ready-to-use towelette, but is distinguished considerably therefrom by its effectiveness. In fact, it advantageously combines the action of a conventional disposable towelette with the scouring effect of the abrasive melamine foam.

In the manufacture of these towelettes, imbibition may be performed both in the region of the melamine foam layer 2 or 2′ and in the region of the reinforcing layer 4 or 4′, if the reinforcing layer 4 or 4′ has sufficient porosity.

Imbibition of the article 1 may be performed before or after the lamination of the various layers. However, in the case of lamination by hot pressure, imbibition subsequent to this stage is preferred as the heat risks causing possible evaporation of the liquid composition and/or possible deterioration of the properties thereof, in particular the chemical properties thereof.

With a comparable purpose, it may also be envisaged to produce an article 1 containing solid particles adapted to release an active agent after dissolution in contact with a liquid, in particular water. These solid particles may be a detergent in powder form or microcapsules with a hydrolyzable wall containing the active agent. An article 1 may simply have these particles at the interface between melamine foam layer 3 or 3′ and reinforcing layer 4 or 4′.

1-41. (canceled)

42. A method for making an article comprising at least one piece of sheet-form melamine foam having a thickness which is sufficiently small to exhibit flexibility and no flexural elasticity, wherein a melamine foam block is cut by peeling into a strip having a thickness which is sufficiently small to exhibit flexibility and no flexural elasticity, and wherein the article is made using at least one piece of sheet-form melamine foam derived from this strip.

43. The method as claimed in claim 42 for making an article having two opposing main free faces with a total thickness which is sufficiently small to exhibit flexibility and no flexural elasticity, wherein at least one layer, known as the reinforcing layer is attached to each piece of melamine foam, so that at least one of the main free faces of said article has a scouring free face formed at least in part by at least one piece of melamine foam.

44. The method as claimed in claim 42, wherein said melamine foam block is cut by peeling into a strip having a thickness of less than or equal to 1 mm.

45. The method as claimed in claim 42, wherein said melamine foam block is cut by peeling into a strip having a thickness of approximately 0.8 mm.

46. The method as claimed in claim 43, wherein each piece of melamine foam is attached to at least one reinforcing layer so as to obtain a melamine foam layer having a main face which defines a scouring free face of the article and, superimposed on the melamine foam layer, a reinforcing layer of this type having a main face that defines the other free face of the article.

47. The method as claimed in claim 43, wherein the reinforcing layer is a layer of melamine foam.

48. The method as claimed in claim 43, wherein the reinforcing layer is made of a material that is different from a melamine foam and is adapted to have tear strength higher than that of the melamine foam.

49. The method as claimed in claim 42, wherein an article is produced, of which at least one of the main free faces is an absorbent free face formed at least in part by at least one piece of absorbent material.

50. The method as claimed in claim 43, wherein an article having at least one reinforcing layer is produced from an absorbent material.

51. The method as claimed in claim 43, wherein an article is produced, which comprises a layer of melamine foam having a main face defining the scouring free face of the article and, superimposed on the melamine foam layer and made of an absorbent material, a reinforcing layer having a main face defining the absorbent free face of the article.

52. The method as claimed in claim 43, wherein the opposing main free faces are both scouring faces and are formed by two distinct layers of melamine foam between which at least one reinforcing layer is interposed.

53. The method as claimed in claim 42, wherein an article having a total thickness of less than 5 mm is produced.

54. The method as claimed in claim 42, wherein an article having a total thickness of approximately 0.85 to 2 mm is produced.

55. The method as claimed in claim 43, wherein each reinforcing layer is produced from a fibrous material mainly containing fibers selected from: cellulose fibers, natural textile fibers, synthetic textile fibers.

56. The method as claimed in claim 43, wherein each reinforcing layer is produced from a material selected from: a cellulose nonwoven, a viscose nonwoven, a perforated cotton nonwoven, a polyamide knit, a cotton gauze, a polyurethane foam, a polyethylene foam.

57. The method as claimed in claim 42, wherein at least a portion of the thickness of said article is impregnated with a liquid composition before being packaged.

58. The method as claimed in claim 57, wherein the liquid composition used is selected from: a detergent, a solvent, a bacteriostatic and/or bactericidal disinfectant composition, water or a mixture thereof.

59. The method as claimed in claim 57, wherein the liquid composition used is selected from: a moisturizing solution, a soap, a deodorant, a perfume, a make-up removing composition, an emollient, an ointment, an antiseptic, water, hydrogen peroxide solution or a mixture thereof.

60. The method as claimed in claim 42, wherein a solid composition capable of dissolving in the presence of a liquid so as to be able to release an active agent is incorporated into at least a portion of the thickness of said article.

61. The method as claimed in claim 42, wherein said article is wrapped in an individual or collective impermeable packaging.

62. The method as claimed in claim 42, wherein the various layers of said article are laminated in pairs by means of an intermediate heat-activable adhesive film.

63. An article comprising at least one piece of sheet-form melamine foam having a thickness which is sufficiently small to exhibit flexibility and no flexural elasticity.

64. The article as claimed in claim 63 comprising two opposing main free faces having a total thickness which is sufficiently small to exhibit flexibility and no flexural elasticity.

65. The article as claimed in claim 63, wherein
at least one of the main free faces is a scouring free face formed at least in part by at least one piece of melamine foam, and
wherein it comprises at least one layer known as the reinforcing layer associated with each piece of melamine foam remote from the part of the scouring free face formed by this piece.

66. The article as claimed in claim 63, wherein at least one of the pieces of melamine foam has a thickness of less than or equal to 1 mm.

67. The article as claimed in claim 63, wherein at least one of the pieces of melamine foam has a thickness of approximately 0.8 mm.

68. The article as claimed in claim 64, wherein at least one of the main free faces is an absorbent free face formed at least in part by at least one piece of absorbent material.

69. The article as claimed in claim 65, wherein it comprises a layer of melamine foam having a main face defining a scouring free face of the article and, superimposed on the layer of melamine foam, a reinforcing layer having a main face defining the other free face of the article.

70. The article as claimed in claim 65, wherein the reinforcing layer is made of melamine foam.

71. The article as claimed in claim 65, wherein the reinforcing layer is made of a material which is distinct from a melamine foam and is adapted to have tear strength that is higher than that of melamine foam.

72. The article as claimed in claim 65, wherein the opposing main free faces are both scouring faces and are formed by two distinct layers of melamine foam between which at least one reinforcing layer is interposed.

73. The article as claimed in claim 63, wherein it has a total thickness of less than 5 mm.

74. The article as claimed in claim 43, wherein it has a total thickness of approximately 0.85 to 2 mm.

75. The article as claimed in claim 65, wherein each reinforcing layer is produced from a fibrous material mainly containing fibers selected from: cellulose fibers, natural textile fibers, synthetic textile fibers.

76. The article as claimed in claim 65, wherein each reinforcing layer is produced from a material selected from: a cellulose nonwoven, a viscose nonwoven, a perforated cotton nonwoven, a polyamide knit, a cotton gauze, a polyurethane foam, polyethylene foam.

77. The article as claimed in claim 63, wherein at least a portion of its thickness is impregnated with a liquid composition before being packaged.

78. The article as claimed in claim 67, wherein the liquid composition is selected from: a detergent, a solvent, a bacteriostatic and/or bactericidal disinfectant composition, water or a mixture thereof.

79. The article as claimed in claim 78, wherein the liquid composition is selected from a moisturizing solution, a soap, a deodorant, a perfume, a make-up removing composition, an emollient, an ointment, an antiseptic, water, hydrogen peroxide solution or a mixture thereof.

80. The article as claimed in claim 63, wherein at least a portion of the thickness thereof comprises a solid composition intended to dissolve in the presence of a liquid so as to be able to release an active agent.

81. The article as claimed in claim 63, wherein it is wrapped in an individual or collective impermeable packaging.

82. The article as claimed in claim 63, wherein the various layers are laminated in pairs by an intermediate heat-activable adhesive film.
